(19) United States
(12) Patent Application Publication
(10) Pub. No.: US 2023/0402638 A1
(43) Pub. Date: Dec. 14, 2023

(54) FUEL CELL STACK WITH AT LEAST TWO CELL SERIES, FUEL CELL DEVICE AND MOTOR VEHICLE

(71) Applicant: AUDI AG, Ingolstadt (DE)

(72) Inventors: Sebastian VOIGT, Heilbronn (DE); Oliver KEITSCH, Heilbronn (DE); Fabian LIPPL, Heilbronn (DE); Armin SIEBEL, Neckarsulm (DE)

(21) Appl. No.: 18/043,565

(22) PCT Filed: Feb. 25, 2022
(86) PCT No.: PCT/EP2022/054787

§ 371 Date: Feb. 28, 2023

(30) Foreign Application Priority Data
Mar. 1, 2021 (DE) 10 2021 104 810.9

(51) Int. Cl. H01M 8/248; H01M 8/04082

(52) U.S. Cl. CPC H01M 8/248; H01M 8/04201; H01M 2250/20; H01M 2008/1095

(57) ABSTRACT

A fuel cell stack accommodated in a housing including a first cover and a second cover, which comprises a tensioning system and a plurality of fuel cells, which are arranged in at least two cell series between a first end plate and a second end plate, which at least the first end plate has media connections and distribution structures for media distribution, wherein the first end plate forms the first cover of the housing. A fuel cell device and a motor vehicle comprising such a fuel cell stack is also provided.

### BACKGROUND

### Technical Field

Embodiments of the invention relate to a fuel cell stack accommodated in a housing. Embodiments of the invention further relate to a fuel cell device and a motor vehicle.

### Description of the Related Art

Fuel cells are used to provide electrical energy through an electro-chemical reaction. Each of the fuel cells comprises an anode, a cathode, and a proton-conductive membrane separating the anode from the cathode and coated with a catalyst to promote the electrochemical reaction. Furthermore, in a fuel cell stack of each fuel cell, bipolar plates are provided on both sides of the membrane to supply the media, namely the reactants and, if necessary, a coolant, and gas diffusion layers are generally used to distribute the reactants supplied in the bipolar plates as uniformly as possible over the entire surface of the membrane coated with the catalyst. To increase the usable power, several fuel cells can be connected in series to form a fuel cell stack.

This plurality of fuel cells combined in a fuel cell stack is generally compressed with the aid of tension elements with a force in the range of several tons, this in order to achieve sufficient contact pressure on the catalyst-coated membrane to reduce ohmic losses and by means of the high compression to prevent leaks at the seals used.

It should, however, be noted that forces occur during operation of the fuel cell stack that can lead to an increase or reduction in the compression force. The increase in the compression force is caused by thermal expansion of the components used, by the pressure used for feeding and distributing the reactants, and by swelling of the membrane used during its hydration.

A reduction in the compression force can be caused by a negative thermal expansion at falling or low temperatures or by the settlement behavior of the gas diffusion layers and the seals, which behavior increases as the service life and thus age of the fuel cell stack becomes longer.

It should also be noted that in the event of increased power requirements, it is also possible to distribute the fuel cells over at least two cell series arranged next to each other, for example if the available installation space requires this, wherein the requirement for compression remains unchanged. It must also be ensured that the media flows are distributed as evenly as possible over the cell series.

DE 11 2007 002 793 B4 describes a fuel cell stack with fuel cells distributed over two cell series arranged between two end plates. These end plates are connected to each other by a pair of tensioning plates. An injection nozzle for a reaction gas is arranged on one of the end plates, wherein the reaction gas line includes an elastic region accommodated in a housing. In DE 10 2019 110 317 A1, a modular range extender system for an electrically powered motor vehicle is disclosed having a plurality of fuel cell stacks, wherein the fuel cells can be arranged in two cell series arranged side by side. Then, at least one of the end plates has the interfaces for the media guides. The media are guided through the two cell series in a U-shaped media guide. The other end plate has a directional bypass for this purpose. DE 10 2015 224 178 A1 shows a redox fuel cell system in which a fuel cell stack with only one cell series is arranged next to a regeneration stack.

### BRIEF SUMMARY

Some embodiments include a fuel cell stack accommodated in a housing having a first cover and a second cover and comprising a tensioning system and a plurality of fuel cells arranged in at least two cell series between one first end plate and one second end plate, from which at least the first end plate has media connections and distribution structures for media distribution, wherein the first end plate forms the first cover of the housing.

Some embodiments provide a fuel cell stack in such a way that its manufacture is simplified. Some embodiments provide an improved fuel cell device and an improved motor vehicle.

The fuel cell stack mentioned at the beginning is characterized in that the first end plate of the fuel cell stack with the media connections is also contemporaneously an integral component of the housing. Since this first end plate also carries the media connections for both cell series, the number of components required is reduced, there is a reduced space requirement, and the number of sealing points is also reduced. The common first end plate with the media connections creates a common assembly group that can be treated as one part in production, such that production processes can be optimized, which is associated with time and cost savings, precisely because the first end plate also forms the first cover of the housing. The application of the first cover as the first end plate is only required once for both cell series, and the compression of the tensioning system for both cell series is also carried out in a single process step, which further reduces the cycle time during production.

The second end plate may form the second cover of the housing, as this again saves components, further integrates the fuel cell stack into the housing, and simplifies handling during production.

There is also the possibility, that at least two side walls arranged on opposite sides of the housing can form the tensioning system that is arranged between the first cover and the second cover, which is to say, the housing is used in an even more multifunctional manner and the integration of the fuel cell stack into the housing is further increased.

If the second cover is formed as a spring cap with at least one spring that is supported on the second end plate, then an improved compensation of tolerances is provided.

The second end plate can thus be formed in several parts and one of the springs can be assigned to each partial plate, such that the cell series can differ in length and the tolerance compensation for each individual cell series takes place to the extent that is individually required.

It is not mandatory that the housing, as a whole, forms the tensioning system, but rather there is also the possibility that tensioning elements are part of the tensioning system arranged between the first cover and the second cover, which is to say, only the covers of the housing form part of the tensioning system, wherein the tensioning elements are formed by tension straps and/or tension rods and/or tie rods.

The advantages and effects mentioned above apply mutatis mutandis to a fuel cell device with such a fuel cell stack and to a motor vehicle with such a fuel cell device, wherein the installation space provided in the motor vehicle can, in particular, be better utilized by the formation of the cell series, with an optimized cost for the production of the complex fuel cell stack.

The features and combinations of features mentioned above in the description, as well as the features and combinations of features mentioned below in the description of the figures and/or shown alone in the figures can be used not only in the combinations indicated in each case, but also in other combinations, or on their own. Thus, embodiments which are not explicitly shown or explained in the figures, but which arise from the elucidated embodiments and can be generated by separate combinations of features, are also to be regarded as encompassed and disclosed herein.

### BRIEF DESCRIPTION OF THE SEVERAL VIEWS OF THE DRAWINGS

Further advantages, features and details will be apparent from the claims, from the following description of embodiments and from the drawings.

FIG. 1 shows a schematic representation of a fuel cell stack having two cell series and which fuel cell stack is tensioned between a first cover and a second cover of a housing by its side walls.

FIG. 2 shows a representation corresponding to FIG. 1 with a second cover formed as a spring cap.

FIG. 3 shows a representation corresponding to FIG. 2 with a second end plate formed from two partial plates.

FIG. 4 shows a representation corresponding to FIG. 2 with a tensioning system formed independently of the side walls of the housing.

### DETAILED DESCRIPTION

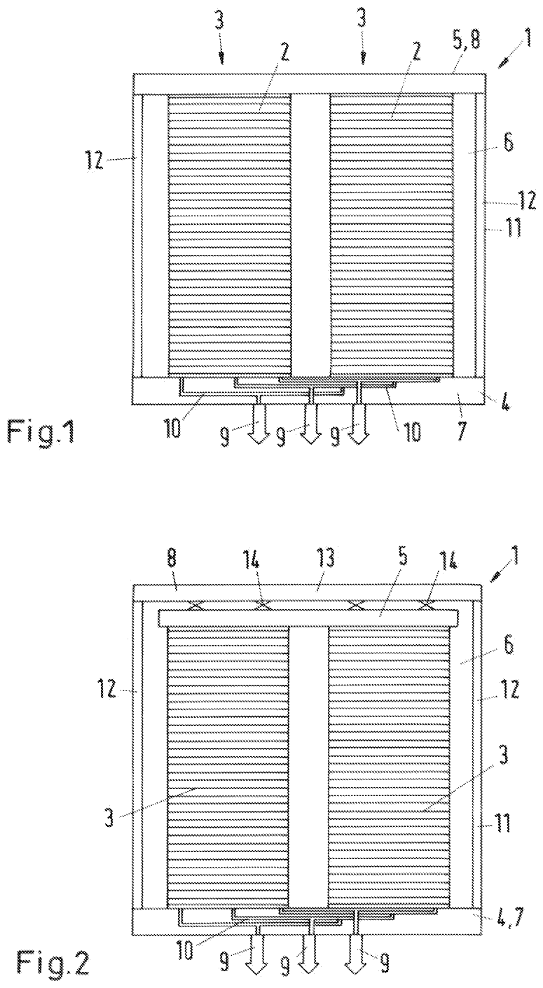

FIG. 1 schematically shows a fuel cell stack 1 consisting of a plurality of fuel cells 2 connected in series. Each of the fuel cells 2 comprises an anode and a cathode, as well as a proton-conducting membrane separating the anode from the cathode. The membrane is formed from an ionomer, such as a polytetrafluoroethylene (PTFE) or a perfluorosulfonic acid (PFSA) polymer. Alternatively, the membrane may be formed as a sulfonated hydrocarbon membrane.

Fuel (for example, hydrogen) is supplied to the anodes via anode chambers within the fuel cell stack 1. In a polymer electrolyte membrane fuel cell (PEM fuel cell), fuel or fuel molecules are split into protons and electrons at the anode. The membrane allows the protons (for example H*) to pass through, however it is impermeable to the electrons (e⁻). The following reaction therefore takes place at the anode: 2H₂→4H⁺+4e⁻ (oxidation/electron release). Whereas the protons pass through the membrane to the cathode, the electrons are conducted to the cathode or to an energy storage device via an external circuit. Cathode gas (for example, oxygen or oxygen-containing air) can be supplied to the cathodes via cathode chambers within fuel cell stack 1, such that the following reaction occurs on the cathode side: O₂+4H⁺+4e⁻→2H₂O (reduction/electron capture).

In the fuel cell stack 1 shown schematically in FIG. 1, the plurality of fuel cells 2 is arranged in two cell series 3, which series are arranged between a first end plate 4 and a second end plate 5. The two cell series 3 are accommodated in a housing 6 with one first cover 7 and one second cover 8. In the embodiment shown, at least one, namely the first end plate 4, has media connections 9 and distribution structures 10 for distributing the media symbolized by arrows. It should be noted that the first end plate 4 forms the first cover 7 of the housing 6. In this embodiment example according to FIG. 1, the second end plate 5 forms the second cover 8 of the housing 6.

The fuel cell stack 1 has a tensioning system 11 acting between the first cover 7 and the second cover 8. In FIG. 1, this is formed by at least two side walls 12 of the housing 6 arranged on opposite sides of the housing 6.

FIG. 2 shows that the second cover 8 can be formed as a spring cap 13 with at least one spring 14, which spring is supported on the second end plate 5. Here too, the side walls 12 of the housing 6 effect the mechanical tensioning of the fuel cell stack 1 with its two cell series 3. The side walls 12 can thus be present individually as separate components; it is simpler and therefore may be preferred if the side walls 12 are combined in the circumferential direction as one component, in particular as a hollow, approximately parallelepiped component.

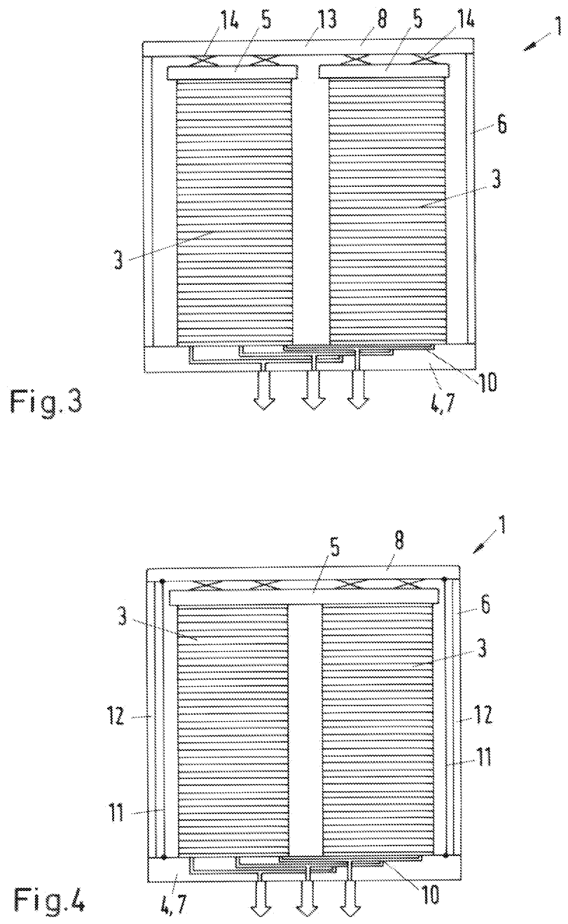

FIG. 3 refers to the fact that the second end plate 5 is formed in several parts and each partial plate is assigned one of the springs 14. This allows the cell series 3 to differ in length, wherein tolerances are compensated for by the springs 14 of the tensioning system 11.

FIG. 4 shows that instead of, or in addition to, the side walls 12 of the housing 6, tensioning elements can also form the tensioning system 11 arranged between the first cover 7 and the second cover 8, the tensioning elements being formed by tensioning straps and/or tensioning rods and/or tie rods.

The use of a fuel cell device with a fuel cell stack 1 of this type enables improved use of space with simplified production, which offers particular advantages for use in a motor vehicle.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A fuel cell stack accommodated in a housing, wherein the housing includes a first cover and a second cover, the fuel cell stack comprising:
a tensioning system; and
a plurality of fuel cells arranged in at least two cell series between a first end plate and a second end plate, of which at least the first end plate has media connections and distribution structures for media distribution, and
wherein the first end plate forms the first cover of the housing.

2. The fuel cell stack according to claim 1, wherein the second end plate forms the second cover of the housing.

3. The fuel cell stack according to claim 2, wherein at least two side walls arranged on opposite sides of the housing are used for the tensioning system arranged between the first cover and the second cover.

4. The fuel cell stack according to claim 1, wherein the second cover is formed as a spring cap with at least one spring supported on the second end plate.

5. The fuel cell stack according to claim 4, wherein the second end plate is formed in multiple parts and one of the springs is assigned to each of the multiple parts.

6. The fuel cell stack according to claim 1, wherein tensioning elements are part of the tensioning system arranged between the first cover and the second cover.

7. The fuel cell stack according to claim 6, wherein the tensioning elements are formed by tensioning straps and/or tensioning rods and/or tie rods.

8. A fuel cell device with a fuel cell stack according to claim 1.

9. A motor vehicle with a fuel cell device having a fuel cell stack according to claim 1.
